(19) United States
(12) Patent Application Publication
(10) Pub. No.: US 2008/0126963 A1
(43) Pub. Date: May 29, 2008

(54) User terminal to manage driver and network port and method of controlling the same

(75) Inventors: Myoung-sim Kim, Daegu (KR); Sang-kil Ahn, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/641,068

(22) Filed: Dec. 19, 2006

(30) Foreign Application Priority Data
Jun. 30, 2006 (KR) 2006-60452

(51) Int. Cl. G06F 3/048

(52) U.S. Cl. 715/764

(57) ABSTRACT

A user terminal to manage a driver and a network port and a method of managing the same can facilitate setup of the driver and the network port using a graphic user interface (UI). The user terminal includes a driver search unit to search installed drivers, a port search unit to search set network ports, a user interface (UI) processing unit to display one or more lists of the searched drivers and the set network ports, and to receive an input of a setup signal for the driver and the network port according to the displayed lists, and a setup processing unit to process a setup of the driver and the network port corresponding to the input setup signal.

### CROSS-REFERENCE TO RELATED APPLICATIONS

This application claims priority under 35 U.S.C. §119(a) from Korean Patent Application No. 2006-60452, filed on Jun. 30, 2006, in the Korean Intellectual Property Office, the entire disclosure of which is hereby incorporated by reference.

### BACKGROUND OF THE INVENTION

1. Field of the Invention

The present general inventive concept relates to a user terminal to manage a driver and a network port and a method of controlling the same. More particularly, the present general inventive concept relates to a user terminal to manage a driver and a network port and a method of managing the same, which can facilitate a setup of the driver and the network port using a graphic user interface (UI).

2. Description of the Related Art

According to increased demands for office automation, a laser beam printer, an FPH (LED Print Head) printer, a copy machine, a facsimile, and so on, among diverse input/output devices, have been increasingly used as an image forming apparatus.

With the development of digital technology, a multifunction device having diverse functions of the existing image forming devices, such as the printer, copy machine, facsimile, and so on, has been introduced.

Generally, a conventional image forming device is locally connected to one user terminal. However, with the development of a network such as a LAN (Local Area Network), one or more user terminals can be connected to one or more image forming devices through the network.

In a system in which one or more user terminals are connected to one or more image forming devices, a user can select and use a desired one of the image forming devices.

In order to use an image forming device through a network, however, a network port of the image forming device intended to be used should be set. This setup process will now be described with reference to FIGS. 1A to 1D.

In order to set a network port of an image forming device in an operating system, for example, in Windows, a “Printers and Faxes” menu A is selected in a “Start-Up” folder as illustrated in FIG. 1A.

When the “Printers and Faxes” menu is selected, as illustrated in FIG. 1B, a window for setting the “Printers and Faxes” is displayed. In the window for setting the “Printers and Faxes”, a list of all image forming devices connected to a user terminal is displayed.

One image forming device of which the network port is to be set is selected through the window for setting the “Printers and Faxes”, and as illustrated in FIG. 1C, a “Properties” window of the corresponding image forming device is made to be activated.

The “Properties” window of the corresponding image forming device as illustrated in FIG. 1C includes taps such as “General”, “Sharing”, “Ports”, “Advanced”, “Color Management”, “Security”, “Printer”, and “Information”. Here, if an “Add Port . . . ” button C is clicked after the “Ports” tap B is selected, a “Printer Ports” window is displayed as illustrated in FIG. 1D.

Then, if a “New Port . . . ” button E is clicked after “Standard TCP/IP Port” D is selected in the “Printer Ports” window, a network port addition wizard is executed to set the network port.

As described above, in order to set the network port of the image forming device, a user should make several selections of menus and buttons through processes in the setup windows illustrated in FIGS. 1A to 1D and during the execution of a network port addition wizard.

These selection processes may be somewhat cumbersome even to an expert, and may be recognized as quite difficult work by a general user, and particularly, by a beginner.

### SUMMARY OF THE INVENTION

The present invention provides a user terminal to manage a driver and a network port and a method of managing the same, which facilitates setup of the driver and the network port by making it possible to connect the driver to the network port with a line on a user interface UI.

Additional aspects and advantages of the present general inventive concept will be set forth in part in the description which follows and, in part, will be obvious from the description, or may be learned by practice of the general inventive concept.

The foregoing and other aspects and advantages of the present general inventive concept may be achieved by providing a user terminal to manage a driver and a network port, the user terminal including a driver search unit to search one or more installed driver, a port search unit to search one or more set network port, a user interface (UI) processing unit to display one or more lists of the searched driver and the set network port, and to receive an input of a setup signal for the driver and the network port according to the displayed lists, and a setup processing unit to process a setup of the driver and the network port corresponding to the input setup signal.

The UI processing unit may indicate a connection state between the driver and the network port in the list with a line. When the UI processing unit generates the line between the driver and the network port, the setup processing unit may set the connection of the driver to the network port. In When the UI processing unit selects the driver and the network port, the selected driver and network port are connected to each other by the line on a UI generated by the UI processing unit, and the setup processing unit may set the connection between the driver and the network port.

The setup signal may be one of a connection signal to connect the driver to the network port, a connection release signal to release the connection between the driver and the network port, a property change signal for the driver, a property change signal for the network port, and a property change signal for the connection between the driver and the network port.

The UI processing unit may display a setup tool box to input the setup signal for the driver and the network port, together with the list. Here, the setup tool box may comprise a generation tool to draw the line for a connection between the driver and the network port, and a deletion tool to delete the line to release the connection between the driver and the network port. In addition, the line for the connection between the driver and the network port through the generation tool may differ in thickness, form, and color, in accordance with properties.

The UI processing unit may display a menu to select one or more methods of grouping and arranging the list in order to receive an input of the method of grouping and arranging the list of the searched driver and the searched network port, together with the list.

The foregoing and/or other aspects of the present general inventive concept may also be achieved by providing a method of managing a driver and a network port, the method including searching one or more installed drivers, searching set one or more network ports, displaying lists of the searched drivers and the set network ports, receiving an input of a setup signal for the driver and the network port according to the displayed list, and processing a setup of the driver and the network port corresponding to the input setup signal.

The displaying of the list may comprise indicating a connection state of the driver and the network port in the list with a line. When the line between the driver and the network port is generated at the step of receiving the input of the setup signal, the processing of the setup may comprise setting the connection between the driver and the network port. When one of the drivers and one of the network ports are selected at the receiving of the input of the setup signal, the selected driver and network port may be connected to each other by the line on a UI, and the processing of the setup may comprise setting the connection between the driver and the network port.

The setup signal may be one of a connection signal to connect the driver to the network port, a connection release signal to release the connection between the driver and the network port, a property change signal for the driver, a property change signal for the network port, and a property change signal for the connection between the driver and the network port.

The displaying of the list may comprise displaying a menu to select one or more methods of grouping and arranging the list in order to receive an input of the methods of grouping and arranging the list of the searched driver and the searched network port, together with the list.

The foregoing and/or other aspects of the present general inventive concept may also be achieved by providing a computer readable recording medium containing computer readable codes to form a program to perform a method of a user terminal, the method including searching one or more installed drivers, searching one or more set network ports, displaying lists of the searched driver and the searched network port, receiving an input of a setup signal for the driver and the network port according to the displayed list, and processing a setup of the driver and the network port corresponding to the input setup signal.

The foregoing and/or other aspects of the present general inventive concept may also be achieved by providing a user terminal to manage one or more drivers and one or more network ports, the user terminal including a driver search unit to search one or more drivers, a port search unit to search one or more network ports, and a user interface processing unit to display a user interface to display the searched one or more network ports and to display one or more lines to indicate one or more connections between the searched one or more drivers and corresponding one of the searched one or more network ports.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A to 1D are views illustrating a conventional process of setting a network port;

FIG. 2 is a block diagram illustrating a user terminal according to an embodiments of the present general inventive concept;

FIGS. 3A and 3B are views illustrating a user interface provided by a UI processing unit of the user terminal of FIG. 2; and

FIG. 4 is a flowchart illustrating a method of managing a driver and a network port according to an embodiment of the present general inventive concept.

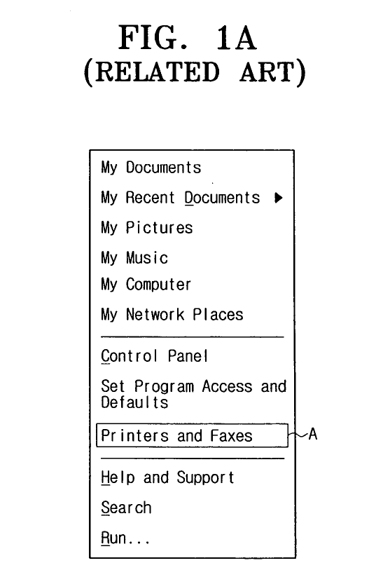

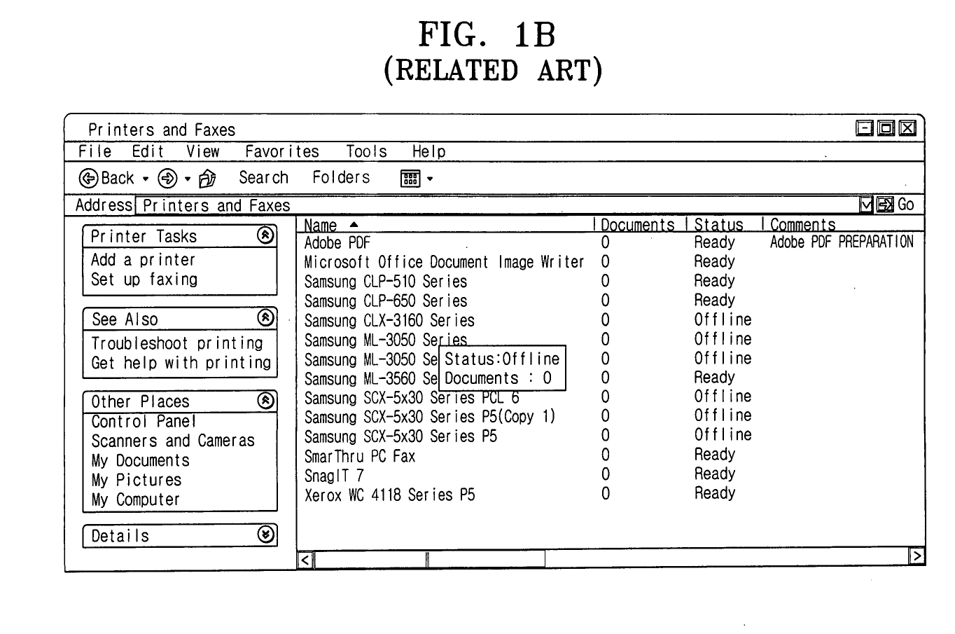

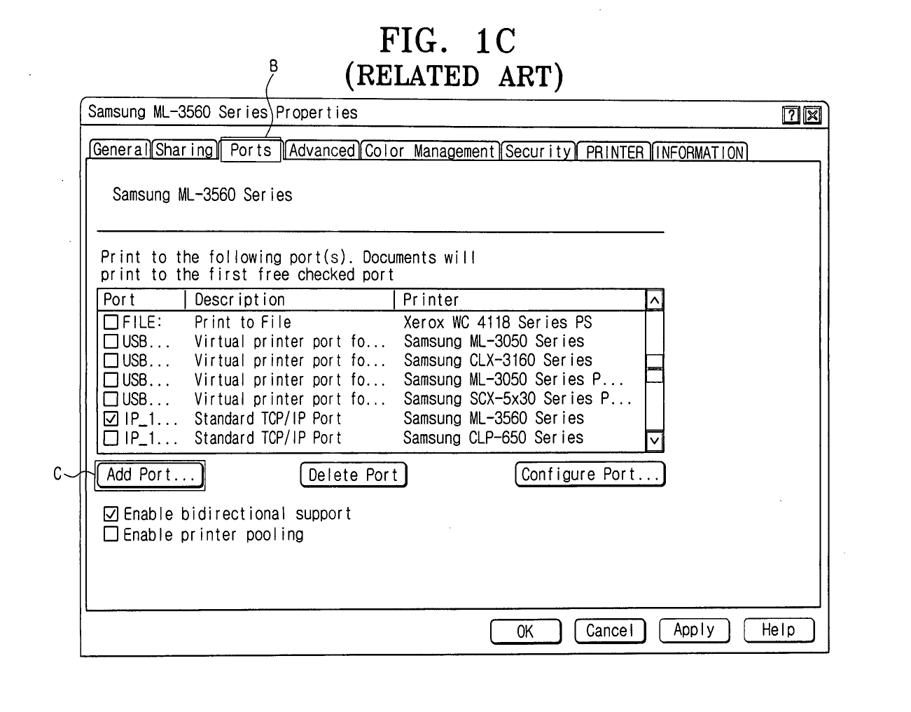

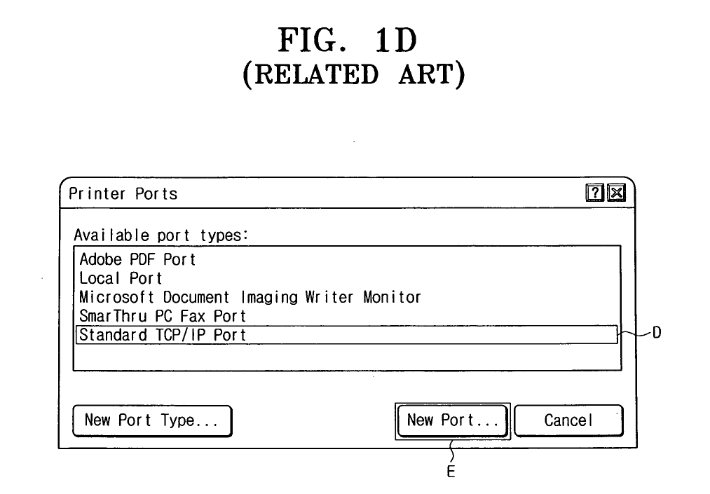

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

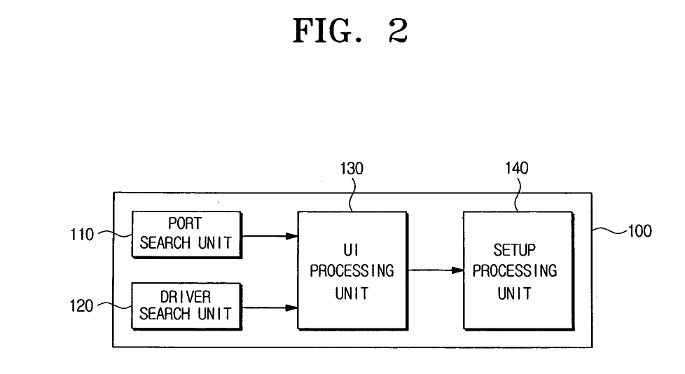

FIG. 2 is a block diagram illustrating a user terminal according to an embodiment of the present general inventive concept.

Referring to FIG. 2, the user terminal 100 may include a port search unit 110, a driver search unit 120, a user interface (UI) processing unit 130, and a setup processing unit 140. In the user terminal 100, a driver of at least one image forming device used by a user is installed, and a plurality of network ports connected to the driver are designated.

The port search unit 110 searches predetermined network ports. At least one network port, which is searched by the port search unit 110, is connected to and used by the driver of the user terminal 100.

The driver search unit 120 searches preinstalled drivers. The driver searched by the driver search unit 120 is a driver program provided by a manufacturer to control the image forming device, and is installed in the user terminal 100 to drive the corresponding image forming device.

The UI processing unit 130 displays a user interface UI to provide one or more lists of network ports searched by the port search unit 110 and drivers searched by the driver search unit 120, in a form that can be easily confirmed by the user. In this case, the UI processing unit 130 indicates a connection state between the driver and the network port, which are included in the lists of the network points and the drivers that are displayed on the UI, using a line.

The UI processing unit 130 receives a setup signal for the driver and the network port in the displayed lists from the user. Here, the setup signal inputted by the user includes any one of a connection signal to connect the driver to the network port, a connection release signal to release the connection between the driver and the network port, a property change signal for the driver, a property change signal for the network port, and a property change signal for the connection between the driver and the network port.

In the present embodiment, the connection signal to connect the driver to the network port may be inputted when the user draws the line to connect the driver to the network port being displayed on the UI, and the connection release signal to release the connection between the driver and the network port may be inputted when the user deletes the line drawn between the driver and the network port to release the connection between the driver and the network port. In addition, various kinds of property change signals may be inputted by selecting any one of the drivers, the network ports, and the connections between the drivers and the network ports, of which property is to be changed, and by selecting a property menu provided in a operating system or application.

The UI processing unit 130 can display a setup tool box to receive an input of the setup signal for the driver and the network port of the lists of the network ports and drivers, together with the list.

The setup processing unit 140 processes a setup of the driver and the network port corresponding to the setup signal received through the UI processing unit 130. The setup corresponding to the setup signal processed by the setup processing unit 140 can be performed according to a conventional driver installation technique.

When the connection signal to connect the driver to the network port is inputted, the setup processing unit 140 sets the connection between the corresponding driver and network port. When the connection release signal to release the connection between the driver and the network port is inputted, it releases the connection between the corresponding driver and network port. In addition, when property change signal for the driver is inputted, the setup processing unit 140 sets the change of the property of the corresponding driver, and when the property change signal for the network port is inputted, it sets the change of the property of the corresponding network port. When the property change signal for the connection between the driver and the network port is inputted, the setup processing unit 140 changes the property of the driver and the network port.

The port search unit 110, the driver search unit 120, the UI processing unit 130 and the setup processing unit 140, as illustrated in FIG. 2, can be implemented by applications to manage the drivers and the network ports.

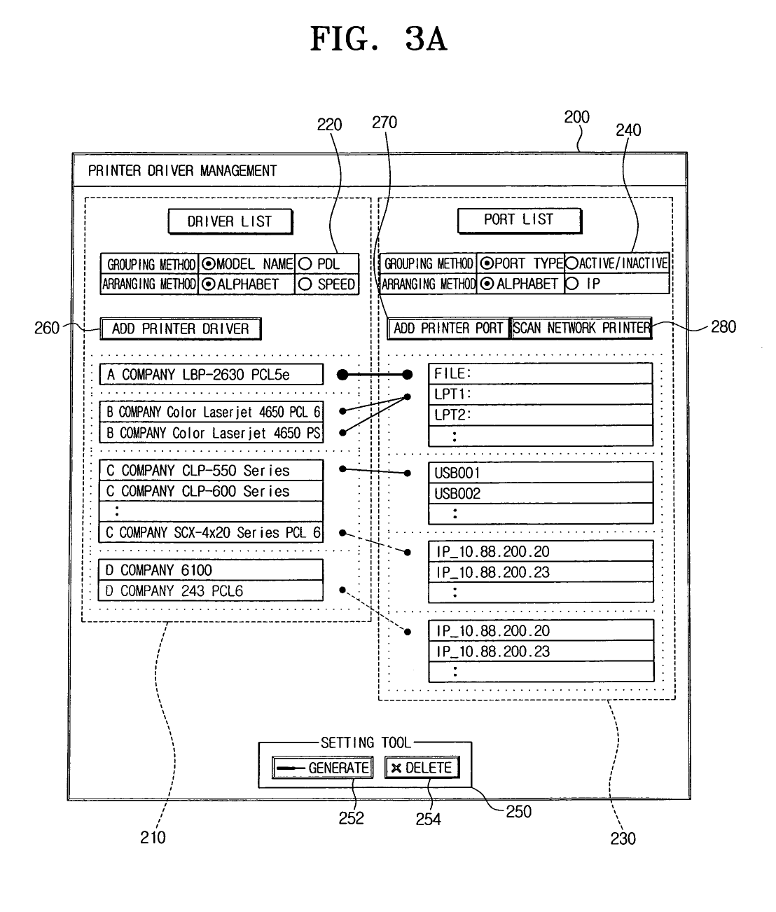

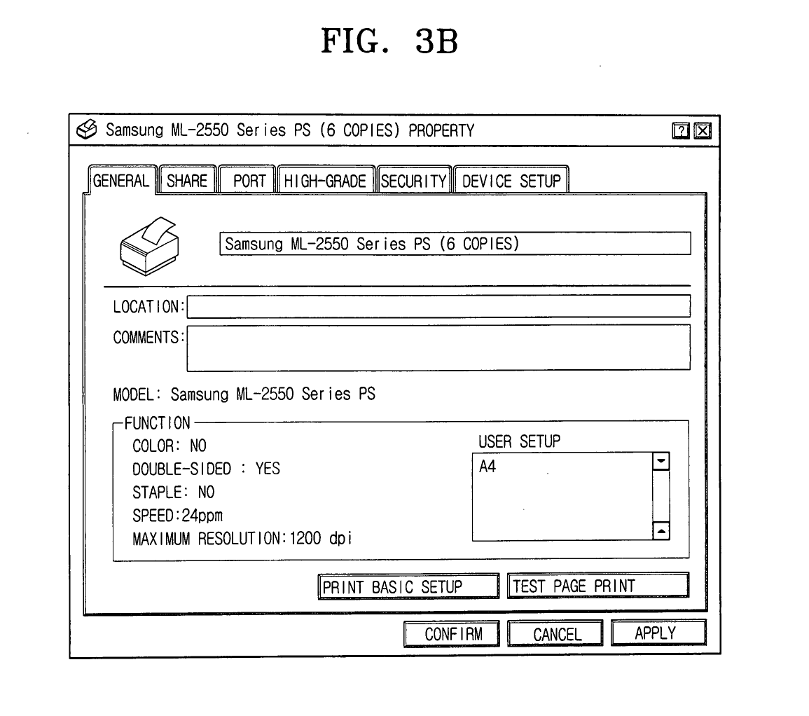

FIGS. 3A and 3B are views illustrating the UI provided by the UI processing unit of the user terminal of FIG. 2.

FIG. 3A illustrates an example of a UI 200 to provide one or more lists of drivers and network ports to a user and to receive an input of a specified setup signal from the user.

On one side of the UI 200 is displayed a driver list 210 is, and on the other side thereof is displayed a port list 230. As illustrated in FIG. 3A, the driver list 210 and the port list 230 may be symmetrically arranged in order to facilitate the connection between the driver and the network port with a line.

The driver list 210 is a list of the drivers searched by the driver search unit 120. If is the drivers are provided in the driver list 210 according to a searched order, a desired driver to be used by the user ma not be easily searched.

If a plurality of drivers are grouped and arranged on a specified order, the user can conveniently retrieve the desired driver. In the present embodiment, a selection menu 220 is provided to input one or more methods of grouping and arranging the drivers and the driver list 210 of the UI 200 is provided.

The driver list 210 may be grouped according to model names of image forming devices and PDL (Page Description Language), and may be arranged in the order of the alphabet or in the order of their processing speed of an image forming operation or a data processing operation.

In the same manner as the driver list 210, a selection menu 240 is provided to input one or more methods of grouping and arranging the port list 230, so that the desired driver can be easily searched.

The network ports may be grouped in the port list 230 according to port types and activated/inactivated state of the ports, and may be arranged in the order of the alphabet or in the order of their speed of performing a data processing operation and/or an image forming apparatus.

Since only one grouping method or one arranging method is selected in the selection menu 220 of the driver list 210 or in the selection menu 230 of the port list 230, it is possible to implement the selection menu 220 or 240 using radio buttons.

In FIG. 3A, when a model name button is selected in the selection menu 220, and the model name is selected as the grouping method in the driver list 210, it can be confirmed that the searched drivers are grouped by manufacturers and are displayed in the menu. Also, when an alphabet button is selected in the selection menu 240, and the alphabet is selected as the arranging method in the port list 230, it can be confirmed that the model names are arranged in the order of the alphabet in the group and are displayed in the menu.

The UI processing unit 130 displays the driver list 210, the post list 230, and the setup tool box 250 in order to receive an input of the setup signals for the driver and the network port.

The setup tool box 250 comprises a generation tool 252 to draw or generate a line to connect the driver to the network port, and a deletion tool 254 to delete the drawn line in order to release the connection between the driver and the network port.

By selecting the generation tool 252, the user may draw the line between the driver and the network port. More specifically, the user may select the generation tool 252 and draw the line, starting from a driver intended to be connected on the UI 200 and ending at a network port. For example, the user puts a cursor on the driver and drags the cursor from the driver to the network port to draw the line between the driver and the network port.

In this case, the line drawn between the driver and the network port by the generation tool 252 may differ in thickness, form and color, according to the properties.

As illustrated in FIG. 3A, a thick line is connected between the driver “A company's LBP-2630 PCL5e” and the network port “FILE:” to indicate a connection between the driver and the network port set by default, and a dotted line is connected between the driver and the network port to indicate that the deriver and the network port are in an inactive connection state, that is, in an unusable state.

As described above, by changing the thickness, form and color of the line connected between the driver and the network port, the user can confirm the state of the driver and the network port more easily.

The UI 200 may further comprise a printer driver addition button 260 to add other drivers to the preinstalled drivers in the driver list 210. This driver addition by the printer driver addition button 260 is performed according to a conventional driver installation technique.

In addition, the UI 200 may further comprise a “printer port addition” button 270 and a “network printer scan” button to add other ports to the preinstalled network ports in the network port list 230.

If the user intends to change the property of a certain driver in the driver list 210, the user selects a property menu by selecting the driver of which the property is to be changed. Accordingly, a property setup window of the corresponding driver is displayed as illustrated in FIG. 3B. Since this is equal to the conventional driver property change method, the detailed description thereof will be omitted.

The property of the network port can be changed by the same method as the driver property change method as described above, and the property of the connection between the driver and the network port can also be changed.

Although FIG. 3A illustrates the generation tool 252 to draw the line from the driver to the network port along a moving path according to a user's manipulation of a mouse, it is also possible that if a user selects the driver and the network port subject to connection, the UI processing unit 130 connects the selected driver to the selected network port with the line. In this case, the generation tool 252 may not be required.

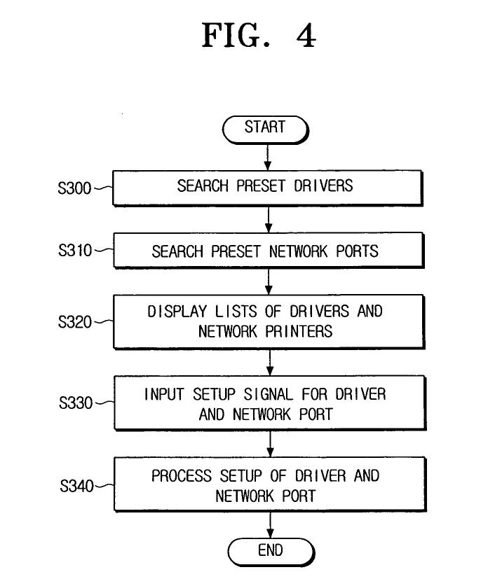

FIG. 4 is a flowchart illustrating a method of managing a driver and a network port according to an embodiment of the present general inventive concept.

Referring to FIGS. 2 to 4, the method of managing the driver and the network port according to the embodiment of the present general inventive concept will be described.

When the port search unit 110, the driver search unit 120, the UI processing unit 130, and the setup processing unit 140 are implemented as a separate application to manage the driver and the network port, a user executes the application to manage or control the driver and the network port.

When the application is executed, the driver search unit 120 searches preinstalled drivers at operation (S300), and the port search unit 110 searches the preset network ports at operation (S310).

The UI processing unit 130 displays through the UI 200 a list of drivers searched through the driver search unit 120 and a list of network ports searched through the port search unit 110. In this case, the lists of the drivers and the network ports are grouped and arranged by preset grouping method and arranging method, and can be changed by the user at operation (S320).

A specified setup signal selected by the user from the displayed driver list 210 and port list 230 is inputted to the UI processing unit 130. In this case, the setup signal may be any one of a connection signal to connect the driver to the network port, a connection release signal to release the connection between the driver and the network port, a property change signal for the driver, a property change signal for the network port, and a property change signal for the connection between the driver and the network port at operation (S330).

If one setup signal according to the user's selection is inputted through the UI processing unit 130, the setup processing unit 140 processes the setup, such as a connection, a connection release, and a property change, in accordance with the input setup signal at operation (S340).

As described above, a network port can be designated to a driver by connecting the driver to the network port with a line, and a connection between the driver and the port can be released by deleting the connected line on the UI. Also, the property change can be easily made through the driver list 210 and the port list 230 displayed in a form that can be easily identified through the UI 200.

The user can perform a print work using an image forming device through the network port connected to the driver, and can delete the unnecessary driver or network port.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As described above, according to a user terminal for managing a driver and a network port and a method of managing the same according to embodiments of the present invention, the setup of the network port can be easily performed without repeated selection processes by providing list of drivers and network ports to a user through a UI and making it possible to connect the driver to the network port with a line on the UI. Also, the user terminal and the method of managing the driver and the network port can provide convenience to the user in performing the connection release and the property change. In particular, in the case of connecting a port that is different from the preset port to the same driver, it is not required to repeat the whole driver installation process.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A user terminal to manage a driver and a network port, the user terminal comprising:
a driver search unit to search one or more installed drivers;
a port search unit to search one or more set network ports;
a user interface (UI) processing unit to display one or more lists of the searched driver and the searched network port, and to receive an input of a setup signal for the driver and the network port according to the displayed lists; and
a setup processing unit to process a setup of the driver and the network port corresponding to the input setup signal.

2. The user terminal of claim 1, wherein the UI processing unit generates an image representing a connection state between the driver and the network port in the list with a line.

3. The user terminal of claim 2, wherein when the UI processing unit generates the line between the driver and the network port, the setup processing unit sets the connection of the driver to the network port which is connected by the line.

4. The user terminal of claim 2, wherein when the UI processing unit selects the driver and the network port, the selected driver and network port are connected to each other by the line on a user interface operated by the user interface processing unit, and the setup processing unit sets the connection between the driver and the network port.

5. The user terminal of claim 2, wherein when the UI processing unit generates a view representing connection states indicated as lines to connect the one or more installed drivers to corresponding ones of the one or more set network ports, and one of the connection states is deleted by the UI processing unit, the setup processing unit releases the connection between the driver and the network port corresponding to the deleted line.

6. The user terminal of claim 1, wherein the setup signal is one of a connection signal to connect the driver to the network port, a connection release signal to release a connection between the driver and the network port, a property change signal for the driver, a property change signal for the network port, and a property change signal for the connection between the driver and the network port.

7. The user terminal of claim 1, wherein the UI processing unit displays a setup tool box to input the setup signal for the driver and the network port, together with the one or more lists.

8. The user terminal of claim 7, wherein the setup tool box comprises a generation tool to draw one of the lines each indicating a corresponding connection between the driver and the network port, and a deletion tool to delete the one of the lines to release the connection between the driver and the network port.

9. The user terminal of claim 8, wherein lines indicating the corresponding connection between the driver and the network port through the generation tool differs from each other in one of thickness, form, and color, in accordance with properties of the driver and the network port.

10. The user terminal of claim 1, wherein the UI processing unit displays a menu to select one or more methods of grouping and arranging the drivers and the network ports the lists in order to receive an input of the method of grouping and arranging the list of the searched drivers and the searched network ports, together with the list.

11. A method of managing a driver and a network port, the method comprising:
searching one or more installed drivers;
searching one or more set network ports;
displaying lists of the searched driver and the searched network port;
receiving an input of a setup signal for the driver and the network port according to the displayed list; and
processing a setup of the driver and the network port corresponding to the input setup signal.

12. The method of claim 11, wherein the displaying of the list comprises indicating a connection state of the driver and the network port in the list with a line.

13. The method of claim 12, wherein when the line between the driver and the network port is generated upon receiving the input of the setup signal, the processing of the setup comprises setting the connection between the driver and the network port.

14. The method of claim 12, wherein:
the receiving of the input of the setup signal comprises selecting the driver and the network port, and connecting the selected driver and network port to each other by the line on a user interface; and
the processing of the setup comprises setting the connection between the driver and the network port.

15. The method of claim 12, wherein:
the receiving the input of the setup signal comprises displaying lines indicating connections between the drivers and corresponding ones of the network ports, and deleting one of the connection states indicated as the lines; and
the processing of the setup comprises releasing the connection between the driver and the network port corresponding to the deleted line.

16. The method of claim 11, wherein the setup signal is one of a connection signal to connect the driver to the network port, a connection release signal to release the connection between the driver and the network port, a property change signal for the driver, a property change signal for the network port, and a property change signal for the connection between the driver and the network port.

17. The method of claim 11, wherein the displaying of the list comprises displaying a menu to select one or more methods of grouping and arranging the drivers and network ports in the lists in order to receive an input of the methods of grouping and arranging the lists of the searched drivers and the searched network port, together with the lists.

18. A computer readable recording medium containing computer readable codes to form a program to perform a method of a user terminal, the method comprising:
searching one or more installed drivers;
searching one or more set network ports;
displaying lists of the searched driver and the searched network port;
receiving an input of a setup signal for the driver and the network port according to the displayed list; and
processing a setup of the driver and the network port corresponding to the input setup signal.

19. A user terminal to manage one or more drivers and one or more network ports, comprising:
a driver search unit to search one or more drivers;
a port search unit to search one or more network ports; and
a user interface processing unit to display a user interface to display the searched one or more drivers and the searched one or more network ports and to display one or more lines to indicate one or more connections between the searched one or more drivers and corresponding one of the searched one or more network ports.

20. The user terminal of claim 19, further comprising:
a setup processing unit to process a setup of the drivers and the network ports according to the connections.

21. The user terminal of claim 19, wherein the lines are different in one of color and shape.

22. The user terminal of claim 19, wherein the user interface comprises a first list to include the searched drivers, a second list to include the searched network ports, and a section disposed between the first list and the second list to include the lines.
